(19) United States
(12) Patent Application Publication
(10) Pub. No.: US 2006/0254445 A1
(43) Pub. Date: Nov. 16, 2006

(54) Printing press with holographic finishing unit

(75) Inventor: Shizuo Masuda, Shizuoka (JP)

Correspondence Address: LADAS & PARRY, 26 WEST 61ST STREET, NEW YORK, NY, 10023, US

(73) Assignee: SHINOHARA MACHINERY CO., LTD.

(21) Appl. No.: 11/416,305

(22) Filed: May 2, 2006

(30) Foreign Application Priority Data
May 11, 2005 (JP) 2005-138274

(51) Int. Cl. B41F 35/00

(52) U.S. Cl. 101/424.1

(57) ABSTRACT

The present invention aims at providing an improved sheet-fed printing press by which simple hologram surface can be, in line, formed on the printed sheet surface.

To effect after-treatment, varnishing unit 24 is provided in succession to printing unit 10 and the varnishing unit 24 coats UV-setting-type varnish on the sheet 22. Following the varnishing unit 24, holographic finishing unit 38 is connected which comprises feeding means 44 for casting film 42 on which formed is hologram surface beforehand. The casting film 42 is led near the periphery of pressure cylinder 40 by feeding means 44 in synchronism with printing speed. Hologram surface of casting film 42 is pressed onto the coated sheet 22 by a pair of rollers 52, 54 which can controllably be positioned at make or break state in relation to the pressure cylinder 40. Between the pair of rollers 52, 54, UV lighting means 56 controllably emits UV ray toward the pressure cylinder 40. Added value of printed matter can efficiently be raised, as hologram surface can be, in line, formed at desired position in synchronism with printing speed.

### BACKGROUND OF THE INVENTION

1. Field of the Invention

The present invention relates generally to sheet-fed printing press, or more precisely, to printing press with holographic finishing unit by which hologram surface can be formed in line.

2. Description of the Prior Art

Variety of after-treatment is executed on the printed sheet to protect, put gloss and enhance aesthetic effect on the surface. For example, varnish coating is executed on the sheet in succession to printing by sheet-fed press with coating unit in line. Recently, there is a need for forming hologram on all or part of sheet surface in order further to raise the added value of printed matter. In general, hologram technique produces diffraction of light by interference pattern. Genuine technique by metal vaporization such as for paper money or identity card is preceded. Instead of such interference pattern, it is possible to produce diffraction of light by minute concave-convex on the sheet and such technique is known as surface relief hologram (emboss method).

For one of these simplified hologram forming technique, it is conceivable to raise aesthetic effect on the printed sheet by coating ultraviolet-setting-type varnish on the printed sheet, forming minute concave-convex on the surface before the varnish is completely set, and then producing rainbow-like reflection by the minute concave-convex. In the concrete, casting film with minute concave-convex (in other words, molding film) is prepared to press it onto UV-setting-type varnish on the sheet surface, and then the varnish is set and the film is peeled. An efficient construction is desired in order to perform such simplified hologram forming technique by sheet-fed printing press in line after multi-color printing and varnishing.

In Japanese published unexamined specification No. 5798/1995, a construction of relief hologram is disclosed by which picture on printed sheet surface can be seen through. In Japanese publish unexamined specification No. 186258/1995, thermo-elastic resin is coated on the printed sheet surface. Heat-resistant film with hologram surface by metal vaporization is pressed onto the resin surface and then cooled and peeled to transfer hologram pattern on the printed matter. But, the technique is not suitable to quick printing, as heating process is necessitated.

Further in Japanese published unexamined specification No. 293048/2002, UV-setting-type coating is pressed onto the printed sheet surface by utilizing web plastic film, and then the coating is set by UV ray and the sheet is peeled. But, the technique remains putting of gloss by UV-setting-type coating and does not refer to hologram effect.

### SUMMARY OF THE INVENTION

In view of above-described problems of prior art technique, the present invention aims at an improved sheet-fed printing press by which simple hologram surface can be, in line, formed on the printed sheet surface.

To achieve the object, holographic finishing unit is connected in succession to varnishing unit which coats ultraviolet-setting-type varnish on sheet surface in the printing press according to the present invention. The holographic finishing unit comprises feeding means of casting film on which hologram surface is formed beforehand. The casting film is led near the periphery of pressure cylinder by the feeding means in synchronism with printing speed and hologram surface of casting film is pressed onto the coated sheet by a pair of rollers which can adjustably be positioned at make or break state in relation to the pressure cylinder. Between the pair of rollers, ultraviolet lighting means controllably emits UV ray toward the pressure cylinder.

In holographic finishing unit, transfer of hologram surface by the casting film, setting of varnish by UV lighting means and peeling of casting film fed by feeding means from the sheet transferred by pressure cylinder can efficiently be carried out in synchronism with printing speed.

These and other objects of the invention will become apparent from the following description with reference to the drawings. But, these show merely an embodiment of the present invention.

### BRIEF DESCRIPTION OF THE DRAWINGS

FIG. 1 is a schematic side view showing an embodiment of printing press with holographic finishing unit according to the present invention.

FIG. 2 is an enlarged side view of the holographic finishing unit.

FIG. 3 is an enlarged sectional view illustrating transfer of hologram surface.

### DESCRIPTION OF PREFERRED EMBODIMENT

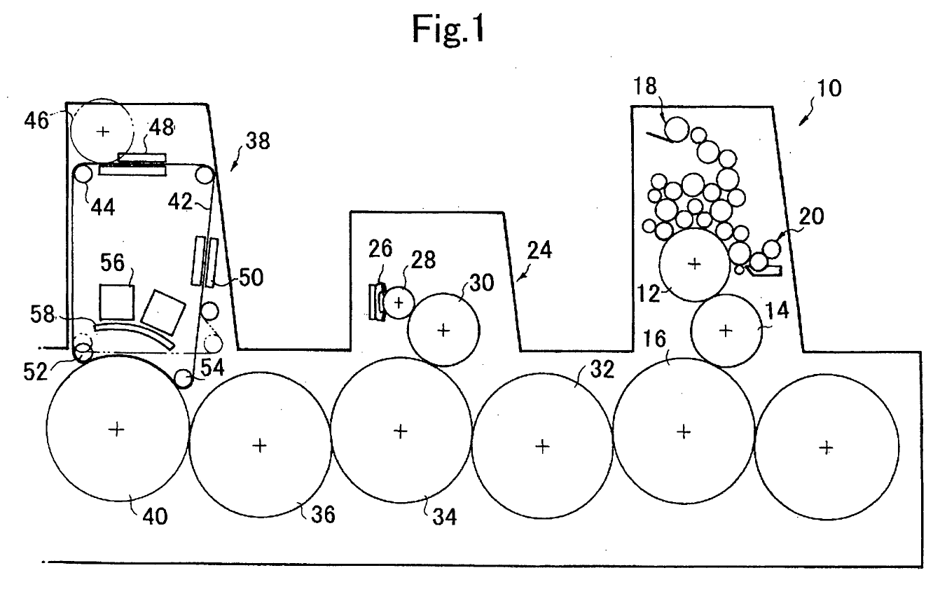

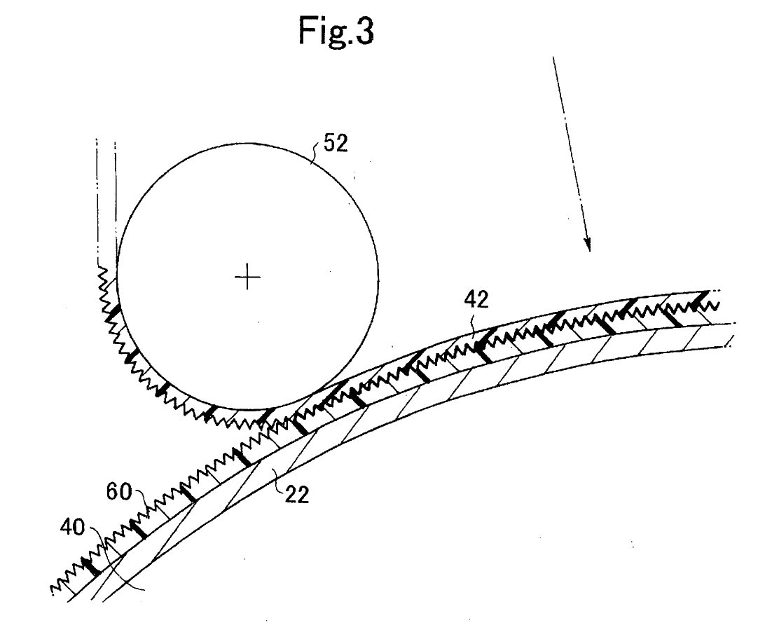

An embodiment of printing press with holographic finishing unit according to the present invention is detailed herein-under with reference to the accompanying drawings. FIG. 1 is a schematic side view of a sheet-fed printing press. Printing unit 10 (one of many units is shown) is by offset printing technique and comprises plate cylinder 12, blanket cylinder 14 and pressure cylinder 16. Ink from inking unit 18 and also dampening water from dampening unit 20 are supplied to the plate around the plate cylinder 12. Once after pictures are transferred to blanket cylinder 14, multi-color printing is effected on sheet 22 (FIG. 3) which is conveyed by pressure cylinder 16.

In succession to printing unit 10, varnishing unit 24 is provided to coat ultraviolet-setting-type varnish on either all or part of the printed sheet 22. Such UV-setting-type varnish is already well-known by prior art technique. Varnish is stored in chamber 26 of varnishing unit 24 and supplied to plate around varnish plate cylinder 30 by way of varnishing roller 28. Then, UV-setting-type varnish is coated on the printed sheet 22 which is transferred from pressure cylinder 16 of printing unit 10 to the transfer cylinder 32 and conveyed by pressure cylinder 34.

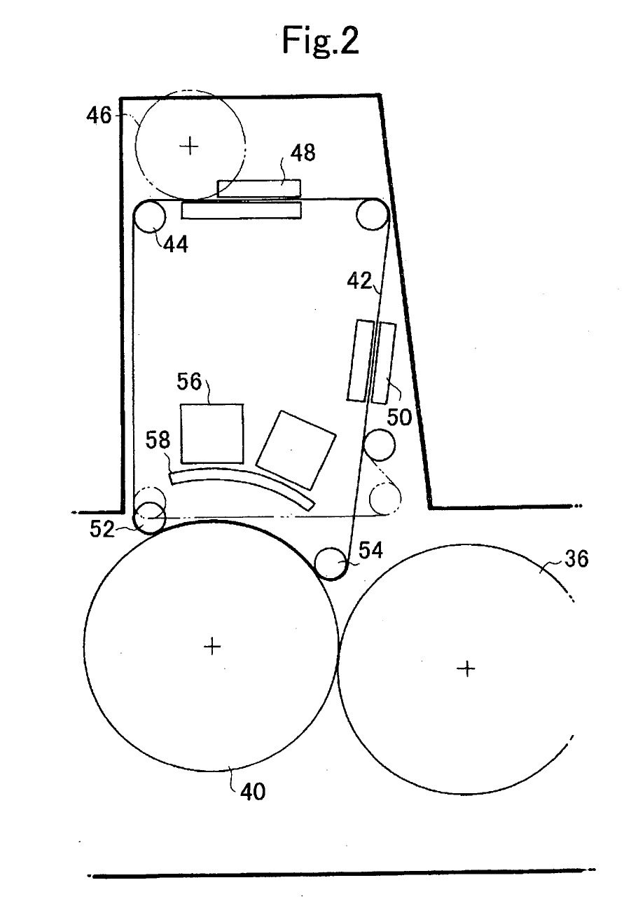

Holographic finishing unit 38 which is in connection with varnishing unit 24 by way of transfer cylinder 38 is also enlarged in FIG. 2. Sheet 22 is transferred from the transfer cylinder 36 to pressure cylinder 40 of holographic finishing unit 38 and further conveyed to delivery unit which is not shown, but positioned in left side of the figure. In other words, sheet 22 is printed, varnished and holographically finished at predetermined time, passing through sheet transfer mechanism composed by numbers of cylinders.

At holographic finishing unit 38, feeding means 44 for casting film 42 on which hologram surface (shown in FIG. 3) is formed beforehand is directed to the periphery of pressure cylinder 40. Technique for forming hologram surface on synthetic resin film such as polyethylene terephthalate by metal evaporation or laser emission is already well-known. The roll of casting film 42 is once prepared in storage 46 and wound around the feeding means 44. The front and rear ends of film 42 are bound together by thermal welding means 48 into endless form for continuous use of the film 42. The reason for providing such storage 46 and thermal welding means 48 is to facilitate in quick exchange, taking into account of durability of casting film 42. Feeding means 44 for casting film 42 with numbers of rollers is driven by drive force from printing press or by independent motor (not shown) and leads endless casting film 44 to the periphery of pressure cylinder 40 in synchronism with the speed of printing press. Cleaning means 50 such as air jet or brush may well be provided en route so as to get rid of dust which may stick on the casting film 42.

Especially in feeding means 42, a pair of rollers 52, 54 which are provided near the periphery of pressure cylinder 40 can adjustably be positioned at make state (shown by solid line) or break state (shown by dotted line) and casting film 42 is pressed onto the sheet 22 between these rollers 52, 54. Make or break adjustment of such rollers 52, 54 is well known, not to mention on cylinder control. Between these pair of rollers 52, 54, ultraviolet lighting means 56 is provided toward the periphery of pressure cylinder 40 and shutter means 58 controls passing and blocking of the light. Varnish layer 60 to which hologram surface is transferred stiffens by the controlled lighting of ultraviolet ray.

Function of above construction is described with reference to FIG. 3. Sheet 22 on which multi-color printing is effected by printing unit 10 as well as UV-setting-type varnish layer 60 is coated reaches the periphery of pressure cylinder 40 of holographic finishing unit 38. Hologram surface of casting film 42 which is led by feeding means 44 is pressed onto the varnish layer 60 between the pair of rollers 52, 54 in order to transfer the holographic surface. After that, shutter means 58 in front of UV lighting means 56 is opened and the varnish layer 60 stiffens so as to strengthen the holographic surface. With the rotation of pressure cylinder 40 as well as advance of casting film 42, the film 42 is peeled off the sheet 22 and then the sheet 22 with hologram surface advances toward delivery.

By printing press with holographic finishing unit according to the present invention, added value of printed matter can efficiently be raised, as hologram surface can, in line and in harmony with printing time, be formed at desired position.

The present invention is not limited to the embodiment described hitherto. Various changes and modifications can, of course, be made without departing from the spirit of the invention.

### DESCRIPTION OF THE REFERENCE NUMERALS

10 printing unit
22 sheet
24 varnishing unit
30 varnishing plate cylinder
38 holographic finishing unit
40 pressure cylinder
42 casting film
44 feeding means
46 storage
48 thermal welding means
52 roller
54 roller
56 ultraviolet lighting means
58 shutter means
60 varnish layer

What is claimed is:

1. Printing press with holographic finishing unit comprising; varnishing unit 24 for after-treatment of the printed sheet 22 in succession to printing unit 10, said varnishing unit 24 coats ultraviolet-setting-type varnish on the sheet 22; holographic finishing unit 38 in succession to the varnishing unit 24, said unit 38 is equipped with feeding means 44 for casting film 42 on which hologram surface is formed beforehand, said feeding means 44 leads the casting film 42 near the periphery of pressure cylinder 40 in synchronism with the printing speed; a pair of rollers 52, 54 which can controllably be positioned at make or break state in relation to the pressure cylinder 40 to press hologram surface of casting film 42 onto the sheet 22; ultraviolet lighting means 56 which controllably emits UV ray toward the pressure cylinder 40 between the rollers 52, 54.
